(19) United States
(12) Patent Application Publication
(10) Pub. No.: US 2026/0204781 A1
(43) Pub. Date: Jul. 16, 2026

(54) Systems and Methods for Mitigating Impedance Variation Across Phased Antenna Arrays

(71) Applicant: Apple Inc., Cupertino, CA (US)

(72) Inventors: Jong Seok Park, San Diego, CA (US); Youngchang Yoon, San Diego, CA (US); Morteza Nick, San Diego, CA (US)

(21) Appl. No.: 19/016,132

(22) Filed: Jan. 10, 2025

(51) Int. Cl. H01Q 3/30; H04B 1/04; H04B 7/0426

(52) U.S. Cl. CPC H01Q 3/30; H04B 1/04; H04B 7/043; H04B 2001/0408

(57) ABSTRACT

An electronic device may be provided with wireless circuitry that includes a phased antenna array. The array may include antennas coupled to power amplifiers. Voltage gain detectors may be coupled around final stages of the amplifiers. The array may transmit a signal within a beam. During transmission, the voltage gain detectors may measure voltage gains of the final stages. Biasing circuitry may adjust bias voltages supplied to the final stages based on the measured voltage gains. The bias adjustments may mitigate the effect of near-field coupling between adjacent antennas and external objects loading the impedance of the set of antennas by different amounts across the phased antenna array by, for example, reducing variation in the voltage gain across the phased antenna array. This may serve to improve performance of the phased antenna array in real time as loading conditions for the array and/or the pointing angle of the beam change.

### FIELD

This disclosure relates generally to electronic devices, including electronic devices with wireless communications circuitry.

### BACKGROUND

Electronic devices are often provided with wireless communications capabilities. An electronic device with wireless communications capabilities has wireless communications circuitry with one or more antennas. The antennas can be arranged in a phased antenna array with beam forming capabilities. It can be challenging to provide phased antenna arrays with sufficient levels of radio-frequency performance.

### SUMMARY

An electronic device may be provided with wireless circuitry. The wireless circuitry may include a phased antenna array. The phased antenna array may include a set of antennas each coupled to a respective power amplifier. Voltage gain detectors may be coupled around final stages of the power amplifiers. The phased antenna array may transmit a radio-frequency signal within a signal beam at a corresponding beam pointing angle.

During signal transmission, the voltage gain detectors may measure voltage gains of the final stages. Biasing circuitry may adjust bias voltages supplied to the final stages based on the measured voltage gains. The bias voltage adjustments may mitigate the effect of complex impedance variation across the phased antenna array incurred when the beam pointing angle of the signal beam changes (e.g., due to near-field coupling between the antennas). The bias voltage adjustments may, for example, reduce variation in the voltage gain across the phased antenna array. This may serve to improve the radio-frequency performance of the phased antenna array in real time as loading conditions for the array and/or the beam pointing angle of the signal beam change over time.

An aspect of the disclosure provides wireless circuitry. The wireless circuitry can include a first antenna fed by a first radio-frequency transmission line path. The wireless circuitry can include a first power amplifier on the first radio-frequency transmission line path and including a first series of amplifier stages. The wireless circuitry can include a first voltage gain detector coupled around a final amplifier stage in the first series of amplifier stages and configured to detect a first voltage gain of the final amplifier stage in the first series of amplifier stages. The wireless circuitry can include biasing circuitry configured to adjust a first bias voltage of the final amplifier stage in the first series of amplifier stages based on the first voltage gain detected by the first voltage gain detector.

An aspect of the disclosure provides wireless circuitry. The wireless circuitry can include a set of antennas configured to transmit radio-frequency signals. The wireless circuitry can include a set of power amplifiers communicatively coupled to the set of antennas. The wireless circuitry can include a set of phase shifters communicatively coupled to the set of antennas, wherein the set of power amplifiers and the set of phase shifters are configured to control the set of antennas to transmit the radio-frequency signals within a signal beam at a beam pointing angle. The wireless circuitry can include a set of voltage gain detectors coupled around final stages in the set of power amplifiers and configured to measure voltage gains of the final stages in the set of power amplifiers while the set of antennas transmits the radio-frequency signals within the signal beam at the beam pointing angle. The wireless circuitry can include biasing circuitry configured to adjust, based on the measured voltage gains, bias voltages supplied to the final stages in the set of power amplifiers while the set of antennas transmits the radio-frequency signals within the signal beam at the beam pointing angle.

An aspect of the disclosure provides a method of transmitting a radio-frequency signal. The method can include transmitting, using a phased antenna array that includes at least a first antenna and a second antenna, the radio-frequency signal within a signal beam. The method can include amplifying, using a first power amplifier biased by a first bias voltage, the radio-frequency signal transmitted by the first antenna. The method can include measuring, using a first voltage gain detector, a first voltage gain of a final amplifier stage in the first power amplifier while the first antenna transmits the radio-frequency signal within the signal beam. The method can include adjusting, using biasing circuitry while the first antenna transmits the radio-frequency signal within the signal beam, the first bias voltage based on the first voltage gain measured by the first voltage gain detector.

### BRIEF DESCRIPTION OF THE DRAWINGS

FIG. 1 is a diagram of an illustrative electronic device having wireless circuitry in accordance with some embodiments.

FIG. 2 is a diagram of illustrative wireless circuitry that includes amplifier circuitry in accordance with some embodiments.

FIG. 3 is a diagram of illustrative wireless circuitry that includes a phased antenna array in accordance with some embodiments.

FIG. 4 is a circuit diagram of an illustrative transmit path of a phased antenna array that includes circuitry for dynamically adjusting the bias voltage of the final stage of a power amplifier based on a voltage gain of the final stage of the power amplifier in accordance with some embodiments.

FIG. 5 is a flow chart of illustrative operations involved in transmitting radio-frequency signals using a phased antenna array while mitigating the effect of impedance angle variations across the phased antenna array in accordance with some embodiments.

FIG. 6 is a plot illustrating how adjusting bias voltage provided to the final stage of power amplifiers may reduce voltage gain variation across a phased antenna array in accordance with some embodiments.

FIG. 7 is a plot illustrating how adjusting bias voltage provided to the final stage of power amplifiers may reduce error vector magnitude of the phased antenna array in accordance with some embodiments.

### DETAILED DESCRIPTION

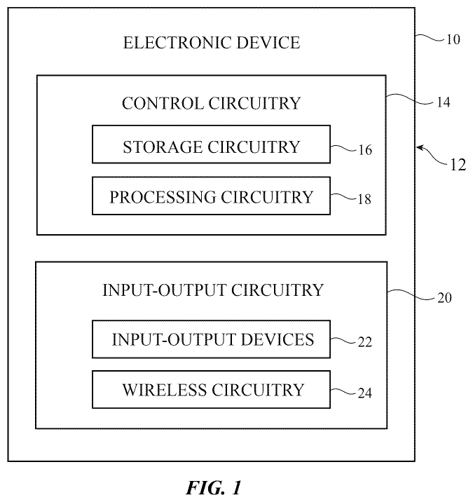

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, a helmet, or other equipment worn on a user's head (e.g., an augmented, virtual, or mixed reality head-mounted display device), or another wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed from plastic, glass, ceramics, fiber composites, metal (e.g., stainless steel, aluminum, metal alloys, etc.), other suitable materials, or a combination of these materials. In some embodiments, parts or all of housing 12 may be formed from dielectric or other low-conductivity material (e.g., glass, ceramic, plastic, sapphire, etc.). In other embodiments, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support or perform radio-frequency signal transmission and/or reception for device 10. Wireless circuitry 24 may be used for wireless communications. Wireless communications performed by wireless circuitry 24 may include or involve wireless data communications (e.g., where wireless data is carried by radio-frequency signals conveyed between wireless circuitry 24 and other communications equipment bidirectionally or unidirectionally), radio-frequency signal transmission, radio-frequency signal reception, and/or radio-based spatial ranging/sensing (e.g., radio detection and ranging (radar) operations, shorter range object detection such as near-field radio-frequency signal-based object detection, etc.). Radio-frequency signals conveyed by wireless circuitry 24 may include or carry wireless data (e.g., organized into frames, packets, symbols, datagrams, etc.), radar or other spatial ranging waveforms, continuous wave signals, chirp signals, control signals, management signals, reference signals, beacon signals, tones, pulses/impulses, waveforms associated with one or more communications protocols, and/or any other radio-frequency waveforms or signals. Wireless circuitry 24 is sometimes also referred to herein as wireless communications circuitry 24, wireless communication circuitry 24, communications circuitry 24, or simply as circuitry 24. Wireless circuitry 24 may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s). Some or all of the components of wireless circuitry 24 may be disposed on, mounted to, communicatively coupled to, and/or integrated within the same substrate (e.g., a printed circuit board, semiconductor substrate, chip, integrated circuit (IC), IC packages, etc.) or may be distributed between two or more substrates (e.g., printed circuit boards, semiconductor substrates, chips, ICs, IC packages, etc.).

Wireless circuitry 24 may transmit and/or receive radio-frequency signals within a corresponding frequency band at radio frequencies (sometimes referred to herein as a communications band or simply as a “band”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1(FR 1 ) bands below 10 GHz, 5G New Radio Frequency Range 2(FR 2 ) bands between 20 and 60 GHz, etc.), other centimeter or millimeter wave frequency bands between 10-100 GHz, sub-THz frequency bands between around 100 GHz and 10 THz (e.g., 6G bands), near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

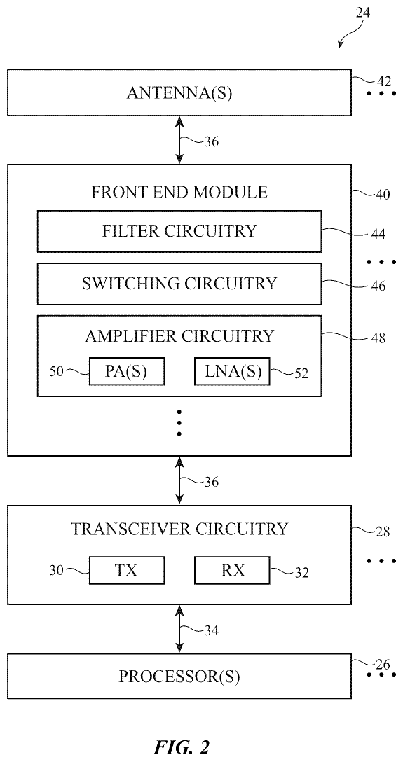

FIG. 2 is a diagram showing illustrative components within wireless circuitry 24. As shown in FIG. 2, wireless circuitry 24 may include processing circuitry such as processing circuitry 26, radio-frequency (RF) transceiver circuitry such as radio-frequency transceiver 28, radio-frequency front-end circuitry such as radio-frequency front-end module (FEM) 40, and antenna(s) 42. Processing circuitry 26 may be coupled to transceiver 28 over baseband path 34. Transceiver 28 may be coupled to antenna 42 via radio-frequency transmission line path 36. Radio-frequency front-end module 40 may be disposed on radio-frequency transmission line path 36 between transceiver 28 and antenna 42.

In the example of FIG. 2, wireless circuitry 24 is illustrated as including only a single transceiver 28, a single front-end module 40, and a single antenna 42 for the sake of clarity. In general, wireless circuitry 24 may include any desired number of transceivers 28, any desired number of front-end modules 40, and any desired number of antennas 42. If desired, processing circuitry 26 may include different processing units (e.g., processors) coupled to one or more transceiver 28 over respective baseband paths 34. Each transceiver 28 may include a transmitter (TX) circuit 30 configured to output uplink signals to antenna 42, may include a receiver (RX) circuit 32 configured to receive downlink signals from antenna 42, and may be coupled to one or more antennas 42 over respective radio-frequency transmission line paths 36. Each radio-frequency transmission line path 36 may have a respective front-end module 40 disposed thereon. If desired, two or more front-end modules 40 may be disposed on the same radio-frequency transmission line path 36. If desired, one or more of the radio-frequency transmission line paths 36 in wireless circuitry 24 may be implemented without any front-end module disposed thereon.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path such that is coupled to the positive antenna feed terminal on antenna 42. Radio-frequency transmission line path 36 may have a ground transmission line signal path that is coupled to the ground antenna feed terminal on antenna 42. This example is merely illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards.

In performing wireless transmission, processing circuitry 26 may provide baseband signals to transceiver 28 over baseband path 34. Transceiver 28 may further include circuitry for converting the baseband signals received from processing circuitry 26 into corresponding radio-frequency signals. For example, transceiver circuitry 28 may include mixer circuitry for up-converting (or modulating) the baseband signals to radio-frequencies prior to transmission over antenna 42. Transceiver circuitry 28 may also include digital-to-analog converter (DAC) and/or analog-to-digital converter (ADC) circuitry for converting signals between digital and analog domains. Transceiver 28 may use transmitter (TX) 30 to transmit the radio-frequency signals over antenna 42 via radio-frequency transmission line path 36 and front-end module 40. Antenna 42 may transmit the radio-frequency signals to external wireless equipment by radiating the radio-frequency signals into free space.

In performing wireless reception, antenna 42 may receive radio-frequency signals from the external wireless equipment. The received radio-frequency signals may be conveyed to transceiver 28 via radio-frequency transmission line path 36 and front-end module 40. Transceiver 28 may include circuitry such as receiver (RX) 32 for receiving signals from front-end module 40 and for converting the received radio-frequency signals into corresponding baseband signals. For example, transceiver 28 may include mixer circuitry for down-converting (or demodulating) the received radio-frequency signals to baseband frequencies prior to conveying the received signals to processing circuitry 26 over baseband path 34.

Front-end module (FEM) 40 may include radio-frequency front-end circuitry that operates on the radio-frequency signals conveyed (transmitted and/or received) over radio-frequency transmission line path 36. FEM 40 may, for example, include front-end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifier circuits 50 and/or one or more low-noise amplifier circuits 52), impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front-end module components may be mounted to a common (shared) substrate such as a rigid printed circuit board substrate or flexible printed circuit substrate. If desired, the various front-end module components may also be integrated into a single integrated circuit chip.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to adjust the frequency response and wireless performance of antenna 42 over time.

Transceiver 28 may be separate from front-end module 40. For example, transceiver 28 may be formed on another substrate such as the main logic board of device 10, a rigid printed circuit board, or flexible printed circuit that is not a part of front-end module 40. While control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, processing circuitry 26 and/or portions of transceiver 28 (e.g., a host processor on transceiver 28) may form a part of control circuitry 14. Control circuitry 14 (e.g., portions of control circuitry 14 formed on processing circuitry 26, portions of control circuitry 14 formed on transceiver 28, and/or portions of control circuitry 14 that are separate from wireless circuitry 24) may provide control signals (e.g., over one or more control paths in device 10) that control the operation of front-end module 40.

Transceiver 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), a Wi-Fi® 7 band, wireless personal area network (WPAN) transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1(FR1 ) bands below 10 GHz, 5G New Radio Frequency Range 2 (FR2) bands between 20 and 60 GHz, 6G bands above 100 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband communications protocols, and/or any other desired radio-frequency transceiver circuitry for covering any other desired communications bands of interest.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna structures, slot antenna structures, planar inverted-F antenna structures, helical antenna structures, monopole antennas, dipoles, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

As described above, front-end module 40 may include one or more power amplifiers (PA) circuits 50 in the transmit (uplink) path. A power amplifier 50 (sometimes referred to as radio-frequency power amplifier circuitry, transmit amplifier circuitry, or amplifier circuitry) may be configured to amplify a radio-frequency signal without changing the signal shape, format, or modulation. Power amplifier 50 may, for example, be used to provide 10 dB of gain, 20 dB of gain, 10-20 dB of gain, less than 20 dB of gain, more than 20 dB of gain, or other suitable amounts of gain.

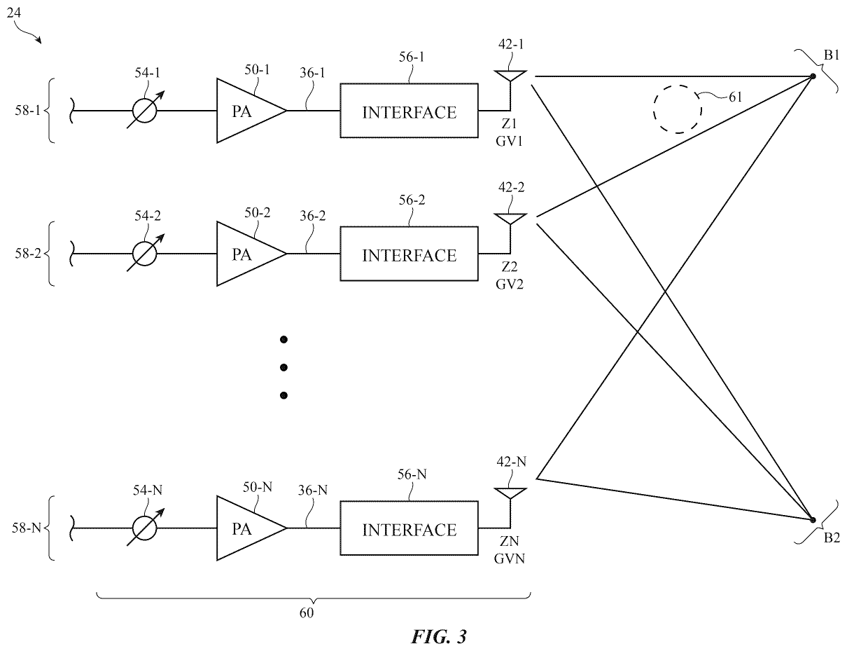

In implementations that are described herein as an example, wireless circuitry 24 may include a set of N antennas 42 that are arranged in a corresponding phased antenna array 60. FIG. 3 is a diagram showing on example of how wireless circuitry may include a phased antenna array 60. As shown in FIG. 3, phased antenna array 60 (sometimes also referred to herein as array 60, antenna array 60, or array 60 of antennas 42) may include N antennas 42 coupled to N respective radio-frequency transmission line paths 36. For example, phased antenna array 60 may include a first radio-frequency transmission line path 36-1 coupled to a first antenna 42-1, a second radio-frequency transmission line path 36-2 coupled to a second antenna 42-2, an Nth radio-frequency transmission line path 36-N coupled to an Nth antenna 42-N, etc. N may be any desired integer greater than or equal to two (e.g., N may be equal to three, four, five, six, seven, eight, 8-16, 8-32, 4-64, 4-128, more than 4, more than 8, etc.). Although antennas 42 are described herein as forming a phased antenna array, the antennas 42 in phased antenna array 60 are sometimes also referred to as collectively forming a single phased array antenna (e.g., where antennas 42 form antenna elements of the phased array antenna).

The N antennas 42 in phased antenna array 60 may be arranged in any desired number of rows and columns or in any other desired pattern (e.g., the antennas need not be arranged in a grid pattern having rows and columns). Each antenna 42 may be separated from one or more adjacent antennas 42 in phased antenna array 60 by a predetermined distance such as approximately half an effective wavelength of operation of the array. During signal transmission, radio-frequency transmission line paths 36 may be used to supply signals (e.g., radio-frequency signals such as millimeter wave and/or centimeter wave signals) from transceiver circuitry to phased antenna array 60 for wireless transmission. During signal reception operations, radio-frequency transmission line paths 36 may be used to supply signals received at phased antenna array 60 (e.g., from external wireless equipment or transmitted signals that have been reflected off of external objects) to transceiver circuitry. Implementations in which phased antenna array 60 transmits radio-frequency signals are described herein for the sake of simplicity and clarity. If desired, phased antenna array 60 may also include signal receiving circuitry for receiving radio-frequency signals.

Each radio-frequency transmission line path 36 of phased antenna array 60 may include respective phase and magnitude controllers. Each phase and magnitude controller may include, for example, a respective phase shifter 54 and a respective power amplifier 50 (e.g., a first phase shifter 54-1 and a first power amplifier (PA) 50-1 may be coupled in series on radio-frequency transmission line path 36-1, a second phase shifter 54-2 and a second PA 50-2 may be coupled in series on radio-frequency transmission line path 36-2, an Nth phase shifter 54-N and an Nth PA 50-N may be coupled in series on radio-frequency transmission line path 36-N, etc.). The power amplifier may be coupled between the phase shifter and the corresponding antenna (as shown in FIG. 3) or, if desired, the phase shifter may be coupled between the power amplifier and the corresponding antenna.

Each radio-frequency transmission line path 36 of phased antenna array 60 may also include a respective radio-frequency interface 56 coupled between its phase and magnitude controller and its antenna 42 (e.g., radio-frequency transmission line path 36-1 may include a first interface 56-1 coupled between PA 50-1 and antenna 42-1, radio-frequency transmission line path 36-2 may include a second interface 56-2 coupled between PA 50-2 and antenna 42-2, radio-frequency transmission line path 36-N may include an Nth interface 56-N coupled between PA 50-N and antenna 42-N, etc.). Each interface 56 may include radio-frequency front end circuitry, filter circuitry, impedance matching circuitry, antenna tuning circuitry, one or more signal couplers, transformers, switching circuitry, duplexer circuitry, diplexer circuitry, multiplexer circuitry, and/or any other desired radio-frequency circuitry.

Each radio-frequency transmission line 36 and the corresponding phase shifter 54, PA 50, interface 56, and antenna 42 are sometimes also referred to collectively herein as a transmit path 58. For example, phased antenna array 60 may include a first transmit path 58-1 that includes radio-frequency transmission line path 58-1, phase shifter 54-1, PA 50-1, interface 56-1, and antenna 42-1, may include a second transmit path 58-2 that includes radio-frequency transmission line path 58-2, phase shifter 54-2, PA 50-2, interface 56-2, and antenna 42-2, an Nth transmit path 58-N that includes radio-frequency transmission line path 58-N, phase shifter 54-N, PA 50-N, interface 56-N, and antenna 42-N, etc. Transmit paths 58 are sometimes also referred to herein as transmit chains 58.

During signal transmission, each radio-frequency transmission line path 36 may carry a radio-frequency signal (e.g., generated by a digital-to-analog converter and upconversion circuitry shared between transmit paths 58-1 through 58-N) for transmission over its corresponding antenna 42. The PA 50 disposed on each radio-frequency transmission line path 36 may amplify the radio-frequency signal on its radio-frequency transmission line path 36 to levels suitable for wireless transmission to external equipment. In addition, the PA 50 may provide the amplified radio-frequency signal with a corresponding signal magnitude for use, in conjunction with a phase shift imparted to the radio-frequency signal by the corresponding phase shifter 54, in beamforming by phased antenna array 60.

Put differently, phase shifters 54 may set and/or adjust the relative phases and/or power amplifiers 50 may adjust the relative magnitudes of the transmitted radio-frequency signals that are provided to each of the N antennas across phased antenna array 60. The term “beam” or “signal beam” is used herein to collectively refer to wireless radio-frequency signals that are transmitted by phased antenna array 60 in a particular direction. Each beam may exhibit a peak gain that is oriented in a respective beam pointing direction at a corresponding beam pointing angle (e.g., based on constructive and destructive interference from the combination of signals from each antenna in the phased antenna array given their relative phases and magnitudes). The beam pointing angle is sometimes also referred to herein as a beam steering angle, a beam steering direction, a beam pointing direction, a beam direction, or a beam angle. Different sets of phase and magnitude settings for the power amplifiers 50 and phase shifters 54 across phased antenna array 60 may configure the phased antenna array to form different beams in different beam pointing directions at different times.

If, for example, phase shifters 54 are adjusted to produce a first set of phases and/or power amplifiers 50 are adjusted to produce a first set of magnitudes for the radio-frequency signal transmitted by phased antenna array 60, the signals will form a first signal beam as shown by beam B1 of FIG. 3 that is oriented in a first direction. If, however, phase shifters 54 are adjusted to produce a second set of phases and/or power amplifiers 50 are adjusted to produce a second set of magnitudes for the radio-frequency signal transmitted by phased antenna array 60, the signals will form a second signal beam as shown by beam B2 of FIG. 3 that is oriented in a second direction different from the first direction. If desired, control circuitry may control phase shifters 54 and power amplifiers 50 to actively adjust the relative phases and magnitudes for the transmitted signals in real time to steer (form) the signal beam in different desired directions over time.

When performing wireless communications using radio-frequency signals at relatively high frequencies such as millimeter and centimeter wave frequencies, radio-frequency signals are conveyed over a line-of-sight path between phased antenna array 60 and external communications equipment. If the external equipment is located in the first direction, phase shifters 54 and power amplifiers 50 may be adjusted to steer the signal beam towards the first direction (e.g., forming beam B1). Phased antenna array 60 may then transmit the radio-frequency signals in the first direction (e.g., over beam B1). Similarly, if the external equipment is located in the second direction, phase shifters 54 and power amplifiers 50 may be adjusted to steer the signal beam towards the second direction (e.g., forming beam B2). Phased antenna array 60 may then transmit the radio-frequency signals in the second direction (e.g., over beam B2).

In the example of FIG. 3, beam steering is shown as being performed over a single degree of freedom for the sake of simplicity (e.g., towards the top and bottom of the page of FIG. 3). However, in practice, the beam may be steered over two or more degrees of freedom (e.g., in three dimensions, into and out of the page and to the top and bottom of the page of FIG. 3). Phased antenna array 60 may have a corresponding field of view over which beam steering can be performed (e.g., in a hemisphere or a segment of a hemisphere over the phased antenna array).

Each antenna 42 may be characterized by a corresponding antenna impedance Z. For example, antenna 42-1 may exhibit impedance Z1, antenna 42-2 may exhibit impedance Z2, antenna 42-N may exhibit impedance ZN, etc. Impedance Z is a complex value having both a magnitude component and a phase component. In an ideal case, phased antenna array 60 transmits radio-frequency signals over a corresponding signal beam while all N antennas 42 exhibit the same uniform impedance Z across phased antenna array 60 (e.g., a free space of 50 Ohm impedance).

However, in practice, one or more external objects such as external object 61 (e.g., a case for device 10, a user or another person's hand, leg, face, ear, finger, or another body part, a tabletop, a desktop, another device 10, furniture, the ground, a car dashboard, a user's pocket, clothing, a pet, animate objects, inanimate objects, etc.) present in the vicinity of phased antenna array 60 may load the impedance of one or more antennas 42 within the array (e.g., shifting the impedance of one or more antennas away from its free space impedance). It is likely that external object 61 will load different antennas 42 by different amounts across phased antenna array 60 (e.g., based on the geometry of phased antenna array 60 and external object 61, where external object is located over or near phased antenna array 60, which antennas 42 are overlapped or not overlapped by external object 61, the distance between external object 61 and each antenna 42, the electromagnetic characteristics of external object 61, etc.). This may, for example, cause a relatively high variation of impedances Z across phased antenna array 60. In addition, antenna impedance can change across the array due to near-field coupling between adjacent antennas in the array, causing the array to exhibit beam angle-dependent antenna impedance variations.

Relatively high variations in the impedances Z across phased antenna array 60 can limit the radio-frequency performance of phased antenna array 60 in transmitting wireless signals. For example, high variations in impedances Z can undesirably produce high variations in the voltage gains GV of the final PA stage in the PAs 50 across phased antenna array 60 (e.g., the final stage of PA 50-1 may exhibit a voltage gain GV1 that is substantially different than the voltage gain GV2 of the final stage of PA 50-2 and/or the voltage gain GVN of the final stage of PA 50-N, etc.). This can undesirably limit the linearity of one or more of the power amplifiers 50 across phased antenna array 60 and/or can limit the error vector magnitude (EVM) of phased antenna array 60.

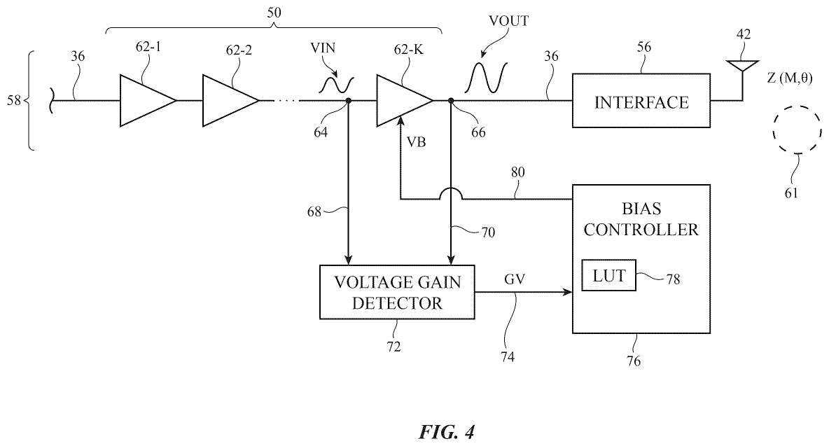

To help mitigate the effect of variations in the impedances Z across phased antenna array 60 on the wireless performance of the array, one or more transmits path 58 in the array (e.g., all N transmit paths 58 in the array) may include circuitry for actively measuring the voltage gain GV of the final stage of PAs 50 in phased antenna array 60 and for dynamically adjusting the bias voltage provided to the PAs in a manner that helps to reduce variation in voltage gain GV across phased antenna array 60 in real time. FIG. 4 is a circuit diagram of an illustrative transmit path 58 in phased antenna array 60 that is provided with circuitry for dynamically adjusting its PA 50 in a manner that helps to reduce variation across phased antenna array 60. The circuitry of FIG. 4 may be used to implement one, more than one, less than all, or all of the N transmit paths 58 in phased antenna array 60. Phase shifter 54 of FIG. 3 has been omitted from FIG. 4 for the sake of clarity.

As shown in FIG. 4, PA 50 may include a set of K power amplifier (PA) stages 62 coupled in series along radio-frequency transmission line path 36 (e.g., PA 50 may include a first PA stage 62-1, a second PA stage 62-2, a Kth PA stage 62-K, etc.). The Kth PA stage 62-K of power amplifier 50 is sometimes also referred to as the last or final PA stage of power amplifier 50 because PA stage 62-K is coupled in series between the remaining (K-1) PA stages 62 in PA 50 and interface 56 (e.g., there are no other PA stages in PA 50 that are coupled between Kth PA stage 62-K and interface 56 or antenna 42). Each PA stage may receive a respective bias voltage that controls the amount of gain produced by that PA stage. The final PA stage 62-K of PA 50 may receive a bias voltage VB that controls the amount of gain imparted by final PA stage 62-K onto the transmitted radio-frequency signal.

Wireless circuitry 24 may include bias voltage control circuitry such as bias controller 80 that generates bias voltage VB and that supplies bias voltage VB to the power supply (bias) input of final PA stage 62-K. Bias controller 80 may also supply bias voltage VB or other bias voltages to the other PA stages 62 of PA 50, but biasing of the first (K-1) PA stages 62 of PA 50 has been omitted from FIG. 4 for the sake of clarity. Each transmit path 58 may have a respective bias controller 80, bias controller 80 may be shared by multiple transmit paths 58, or bias controller 80 may be shared by all N transmit paths 58 in phased antenna array 60. Bias controller 80 may include digital circuitry/logic, one or more processors (e.g., in processor(s) 26 of FIG. 2), storage such as one or more look up tables (LUTs) 78, envelope amplifiers, envelope tracking circuitry, low-dropout (LDO) regulators, filters, and/or any other circuitry for generating bias voltages that power amplifier 50.

During signal transmission, a radio-frequency signal may be incident upon the input of final PA stage 62-K at a relatively low input voltage VIN (e.g., as produced via amplification by the first (K-1) PA stages 62 in power amplifier 50). Input voltage VIN may have an associated input power PIN. Final PA stage 62-K may amplify the radio-frequency signal to produce an amplified radio-frequency signal at its output. The amplified radio-frequency signal may be at a relatively high output voltage VOUT (e.g., the output voltage level of power amplifier 50). Output voltage VOUT may have an associated output power POUT (e.g., the output power level of power amplifier 50). Final PA stage 62-K may transmit the amplified radio-frequency signal at output voltage VOUT to interface 56.

The gain of final PA stage 62-K may be characterized by a voltage gain GV and/or by a power gain GP. Power gain GP is defined by the output power level POUT of final PA stage 62-K divided by the input power level PIN of final PA stage 62-K. Voltage gain GV is defined by the output voltage level VOUT of final PA stage 62-K divided by the input level VIN of final PA stage 62-K (e.g., GV=VOUT/VIN). Due to near-field coupling between adjacent antennas, each antenna impedance Z can change depending on the present beam steering angle. This antenna impedance variation may, for example, be represented by a VSWR 2:1 circle on a Smith chart (e.g., where each angle on the Smith chart is characterized by a corresponding antenna angle θ). In general, antenna impedance Z can change due to near-field coupling among adjacent antennas and can cause beam steering angle dependent complex antenna impedance variation (e.g., antenna angle θ on a VSWR 2:1 Smith chart circle may represent variation in impedance Z) If care is not taken, excessive variation in impedance Z across phased antenna array 60 can cause excessive variation in the voltage gain GV of the final PA stage 62-K in the N power amplifiers 50 across phased antenna array 60.

To help mitigate the effect of variations in antenna angle θ across phased antenna array 60 (e.g., as caused by differential loading by external object 61 and/or near-field coupling between antennas), such as the production of excessive variations in the voltage gain GV of the final amplifier stage 62-K of the PAs 50 across phased antenna array 60, transmit path 58 may include voltage gain measurement (detection) circuitry such as voltage gain detector 72. Voltage gain detector 72 may be coupled around final PA stage 62-K and may be coupled between radio-frequency transmission line path 36 and bias controller 80. For example, voltage gain detector 72 may have a first input coupled to the input of final PA stage 62-K (e.g., at node 64 on radio-frequency transmission line path 36 between the input of final PA stage 62-K and the output of the previous PA stage of PA 50) over a first signal line 68. Voltage gain detector 72 may also

have a second input coupled to the output of final PA stage 62-K (e.g., at node 66 on radio-frequency transmission line path 36 between the output of final PA stage 62-K and the input of interface 56) over second signal line 70. Voltage gain detector 72 may have an output coupled to

a control input of bias controller 76 over signal line 74. Nodes 64 and 66 may include signal splitters or signal couplers, as two examples. The bias controller(s) 76 of phased antenna array 60 are sometimes referred to collectively as bias circuitry, biasing circuitry, or power supply circuitry of phased antenna array 60.

During signal transmission, voltage gain detector 72 may receive input voltage VIN of the transmitted radio-frequency signal from radio-frequency transmission line path 36 over signal path 68. Final PA stage 62-K may amplify the radio-frequency signal. Voltage gain detector 72 may receive the corresponding output voltage VOUT of the transmitted radio-frequency signal from radio-frequency transmission line path 36 over signal path 70. Voltage gain detector 72 may measure (e.g., detect, compute, calculate, identify, etc.) the magnitude of input voltage VIN and the magnitude of the corresponding output voltage VOUT produced by final PA stage 62-K. Voltage gain detector 72 may then generate (e.g., calculate, compute, output, produce, identify, etc.) the present voltage gain GV of final PA stage 62-K based on the measured input voltage VIN and the measured output voltage VOUT (e.g., as GV=VOUT/VIN). Voltage gain detector 72 may transmit voltage gain GV (or a control signal that includes or identifies voltage gain GV) to bias controller 76 over signal path 74.

Voltage gain detector 72 may include any desired analog and/or digital circuitry/logic for generating voltage gain GV based on the measured input voltage VIN and the measured output voltage VOUT. As one example voltage gain detector 72 may include a first voltage detector coupled to signal line 68 that detects input voltage VIN, a second voltage detector coupled to signal line 66 that detects output voltage VOUT, and digital logic gates that generate voltage gain GV based on the detected input voltage VIN and the detected output voltage VOUT (e.g., by dividing output voltage VOUT by input voltage VIN). This is illustrative and, in general, voltage gain detector 72 may include any desired circuitry that generates voltage gain GV based on input voltage VIN and output voltage VOUT.

Bias controller 80 may adjust the bias voltage VB supplied to final PA stage 62-K based on the present voltage gain GV of final PA stage 62-K (e.g., as measured by voltage gain detector 72 and supplied to bias controller 76 over signal path 74). The adjustment to bias voltage VB may be an adjustment that serves to reduce the variation in voltage gain GV across phased antenna array 60. Bias controller 76 may, for example, increase the magnitude of bias voltage VB in response to the present voltage gain GV being relatively low and may decrease the magnitude of bias voltage VB in response to voltage gain GV being relatively high.

If desired, as one example, bias controller 80 may identify or select a particular bias voltage VB to use based on entries stored in LUT 78. LUT 78 may, for example, store calibrated magnitudes for bias voltage VB under each possible measured voltage gain GV (e.g., bias voltages VB that are calibrated to optimize the performance of phased antenna array 60) and may select the corresponding magnitude of bias voltage VB from LUT 78 for the present voltage gain GV measured by voltage gain detector 72. This is illustrative and non-limiting and, in general, bias controller 80 may adjust bias voltage VB based on the measured voltage gain GV using any desired voltage adjustment/generation scheme.

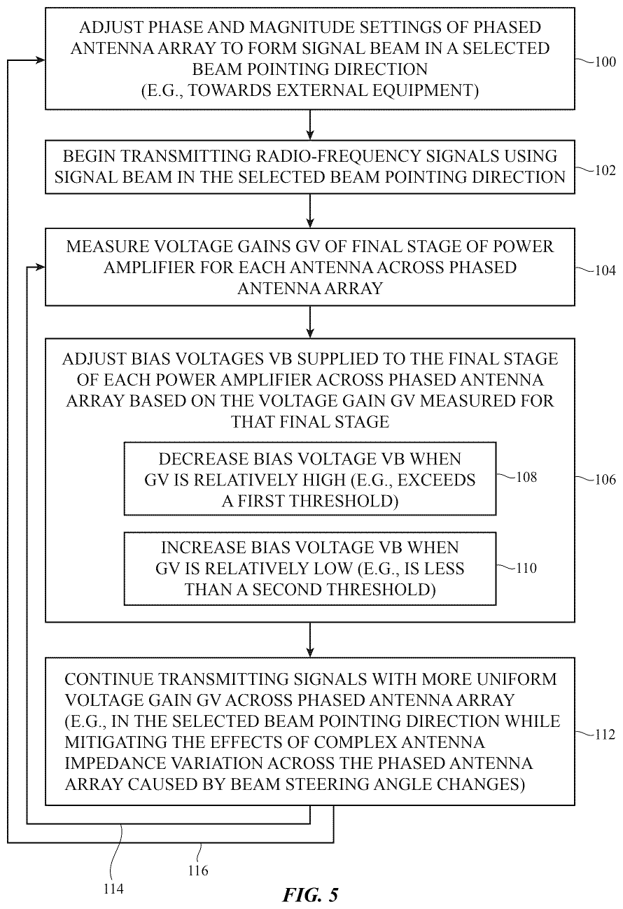

By independently performing this type of bias voltage adjustment to the final PA stage 62-K in some or all of the N transmit paths 58 across phased antenna array 60, the variation in voltage gain GV across phased antenna array 60 may be reduced or minimized in real time (e.g., as different beam steering angles and thus variations in antenna impedance Z across phased antenna array 60 changes), helping to optimize the radio-frequency performance of phased antenna array 60. FIG. 5 is a flow chart of illustrative operations involved in transmitting radio-frequency signals using phased antenna array 60.

At operation 100, control circuitry 14 (FIG. 1) may control the phase and magnitude settings of the phase and magnitude controllers on the N transmit paths 58 of phased antenna array 60 to configure phased antenna array 60 to form a corresponding signal beam in a selected beam pointing direction (e.g., oriented towards external communications equipment). For example, control circuitry 14 may provide control signals to the N phase shifters 54 and may control bias controller(s) 76 (FIG. 4) to provide bias voltages to the N power amplifiers 50 across phased antenna array 60 in a manner that configures phased antenna array 60 to form a signal beam in the selected beam pointing direction. The selected beam pointing direction may be determined from one or more beam measurement sweeps (e.g., sweeps over different beam pointing angles until a beam that exhibits peak performance is found), orientation, location, and/or motion sensor data generated by device 10 (e.g., to ensure that the signal beam continues to point towards the external equipment even as device 10 moves or rotates over time), a communications schedule for device 10 (e.g., as maintained by a wireless network in communication with device 10), one or more software applications running on device 10, etc.

At operation 102, phased antenna array 60 may begin transmitting radio-frequency signals in the signal beam at the selected beam pointing direction.

At operation 104, the voltage gain detector 72 in each of the N transmit paths 58 of phased antenna array 60 may concurrently measure the voltage gain GV of the final PA stage 62-K of the power amplifier 50 in its corresponding transmit path (e.g., by directly measuring the input voltages VIN and the output voltages VOUT of the radio-frequency signal as transmitted by final PA stages 62-K in real time during signal transmission). For example, voltage gain detectors 72 may measure voltage gain GV1 for the final PA stage 62-K in PA 50-1 of FIG. 3, may measure voltage gain GV2 for the final PA stage 62-K in PA 50-2 of FIG. 3, may measure voltage gain GVN for the final PA stage 62-N in PA 50-N of FIG. 3, etc. The magnitude of each measured voltage gain GV may be associated with the antenna impedance of the corresponding antenna 42 (e.g., as characterized by antenna angle θ on a VSWR 2:1 Smith chart circle) given the present beam steering angle of phased antenna array 60.

At operation 106, bias controller(s) 76 may generate different respective bias voltages VB to be concurrently supplied to the final PA stage 62-K in each of the N power amplifiers 50 across phased antenna array 60 based on the measured voltage gains GV of the final PA stage 62-K in that power amplifier 50. For example, bias controller(s) 76 may supply a first bias voltage VB to the final PA stage 62-K in power amplifier 50-1 that has a first magnitude selected based on the measured voltage gain GV1 of the final PA stage 62-K in power amplifier 50-1, may supply a second bias voltage VB to the final PA stage 62-K in power amplifier 50-2 that has a second magnitude selected based on the measured voltage gain GV2 of the final PA stage 62-K in power amplifier 50-2, may supply an Nth bias voltage VB to the final PA stage 62-K in power amplifier 50-N that has an Nth magnitude selected based on the measured voltage gain GVN of the final PA stage 62-K in power amplifier 50-N, etc. If desired, the adjustment may be performed based on calibrated bias voltage settings stored in LUT 78.

The adjustment to bias voltages VB may include, for example, decreasing the bias voltage VB provided to the final PA stage 62-K in a given power amplifier 50 if/when the measured voltage gain GV for the final PA stage 62-K of that power amplifier 50 is relatively high (at operation 108). This may include, for example, decreasing bias voltage VB in response to the measured voltage gain GV exceeding a first threshold value TH1. Additionally or alternatively, the adjustment to bias voltages VB may include, for example, increasing the bias voltage VB provided to the final PA stage 62-K in a given power amplifier 50 if/when the measured voltage gain GV for the final PA stage 62-K of that power amplifier 50 is relatively low (at operation 110). This may include, for example, increasing bias voltage VB in response to the measured voltage gain GV being less than a second threshold value TH2. These voltage gain-based adjustments to bias voltages VB may serve to minimize the magnitude of variation in voltage gain GV for the final PA stage 62-K across the N power amplifiers 50 in phased antenna array 60 given the currently formed signal beam under the present loading conditions of the phased antenna array.

At operation 112, phased antenna array 60 may continue to transmit radio-frequency signals (e.g., where the final PA stages 62-K across the N power amplifiers 50 in phased antenna array 60 are biased using bias voltages VB generated based on the measured voltage gains GV of the final PA stages). Phased antenna array 60 may transmit the radio-frequency signals within the formed signal beam with a more uniform voltage gain GV across phased antenna array 60 than in implementations where bias voltages VB were not adjusted based on the measured voltage gains GV. This may help to optimize the radio-frequency performance of phased antenna array 60 despite a relatively high antenna impedance variation across phased antenna array 60. Adjusting bias voltages VB based on measured voltage gains GV across phased antenna array 60 may allow for rapid and low-cost adjustment to the phased antenna array based on its dynamic beam steering angle in a manner that optimizes performance while consuming minimal processing resources.

As the beam steering angle of the phased antenna array change, the voltage gains GV across the phased antenna array may change and the bias voltages VB supplied to the final PA stage 62-K in the N power amplifiers 50 across phased antenna array 60 may be updated to reduce or minimize variation in voltage gain GV given the changed antenna impedance conditions. Processing may loop back to operation 104 via path 114 to update bias voltages VB based on new measurements of voltage gain GV (e.g., as loading conditions change over time). If desired, processing may loop back to operation 104 via path 114 periodically (e.g., phased antenna array 60 may perform periodic voltage gain measurement and corresponding bias voltage adjustment), in response to the measured voltage gain changing, and/or in response to any desired trigger condition. If desired, voltage gain GV may be measured for some but not all of the transmit paths 58 in the phased antenna array and operations 104-106 may be performed by those transmit paths 58 instead of all transmit paths 58 (e.g., bias voltage adjustments based on measurements of voltage gain GV may be performed for one, more than one, or all transmit paths 58 of phased antenna array 60).

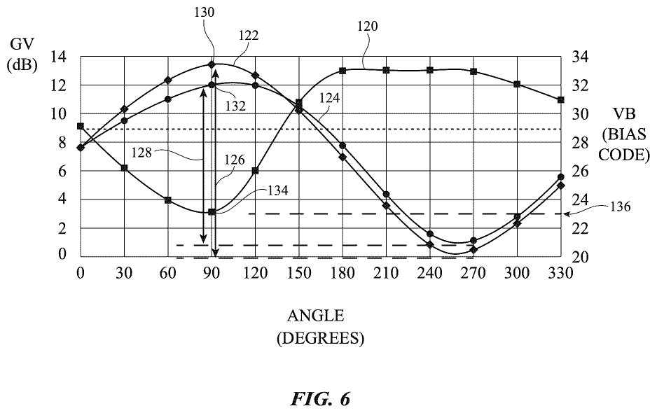

FIG. 6 is a plot illustrating how adjusting the bias voltage VB supplied to the final PA stage 62-K in power amplifiers 50 across phased antenna array 60 may serve to reduce variation in voltage gain GV across phased antenna array 60. Curve 132 plots the voltage gain GV of the final PA stage 62-K in a given power amplifier 50 as a function of the antenna angle (e.g., antenna impedance at a VSWR 2:1 circle with angles θ, in degrees) for its corresponding antenna 42 in the absence of adjustments to bias voltage VB by voltage gain detector 72 and bias controller 76 (e.g., in implementations where operation 106 of FIG. 5 is omitted). Different antenna impedances (at the VSWR 2:1 circle with angles θ) may correspond to different loading conditions of the antenna (e.g., different impedances Z of antenna 42 caused by different beam steering angles). When a constant bias voltage VB is supplied to final PA stage 62-K over time even as antenna impedance changes, final PA stage 62-K may exhibit a voltage gain GV characterized by curve 122.

Curve 120 plots the bias voltage VB (e.g., bias code) that is provided to final PA stage 62-K based on the measured voltage gain GV of final PA stage 62-K across different antenna impedance at a VSWR 2:1 circle with angles θ (e.g., while processing operation 106 of FIG. 5). Curve 120 may, for example, be stored in LUT 78 of bias controller 76 (FIG. 4). Curve 124 plots the voltage gain GV of final PA stage 62-K after bias voltage VB has been adjusted at different antenna impedance at a VSWR 2:1 circle with angles θ (e.g., after bias voltage VB has been adjusted to the bias voltage represented by curve 120). For example, if/when voltage gain detector 72 measures a voltage gain GV of final PA stage 62-K corresponding to point 130 on curve 122, this may be indicative of antenna 42 being loaded in a manner that causes the antenna to exhibit an antenna impedance at the VSWR 2:1 circle with an angle of around 90 degrees. Bias controller 70 may identify the point on curve 120 overlapping point 130 and the antenna impedance at the VSWR 2:1 circle with the angle of 90 degrees and may use the bias voltage VB identified by that point to bias final PA stage 62-K. For example, bias controller 70 may supply a bias voltage VB at the magnitude 136 of point 134 to final PA stage 62-K (e.g., bias controller 70 may reduce bias voltage VB from a nominal, initial, or default magnitude to the magnitude 136 corresponding to point 134 responsive to the measured voltage gain GV being equal to the magnitude associated with point 130). After final PA stage 62-K has been biased using a bias voltage VB at the magnitude corresponding to point 134 of curve 120, final PA stage 62-K may exhibit a voltage gain GV given by point 132 on curve 124, which is lower than point 130.

By performing this type of voltage-gain-based bias voltage adjustment across the N PA final PA stages 62-K in phased antenna array 60, the bias controller(s) may configure phased antenna array 60 to exhibit a reduced or minimal variation in voltage gain GV across the N power amplifiers 50 of phased antenna array 60. For example, as shown by curve 130, prior to adjusting bias voltage VB, voltage gain GV varies by a relatively high margin 126 as a function of antenna impedance at the VSWR 2:1 circle with angle θ. Because different antennas 42 in phased antenna array 60 will exhibit different antenna impedance given the present loading conditions of the array, the phased antenna array will exhibit a relatively large variation in voltage gain (e.g., by as large as margin 126) without adjustment to bias voltages VB. On the other hand, as shown by curve 124, after adjusting bias voltage VB (e.g., according to curve 120), voltage gain GV varies by a smaller margin 128 as a function of antenna impedance at the VSWR 2:1 circle with angle θ. Because different antennas 42 in phased antenna array 60 will exhibit different antenna impedance given the present loading conditions of the array, the phased antenna array will exhibit a smaller variation in voltage gain (e.g., by as large as margin 128) across the N transmit paths 58 of phased antenna array 60. By dynamically measuring voltage gains GV and adjusting bias voltages VB over time, the bias controller(s) may continue to minimize variation in voltage gain across phased antenna array 60 even as loading condition (e.g., beam steering angle) changes.

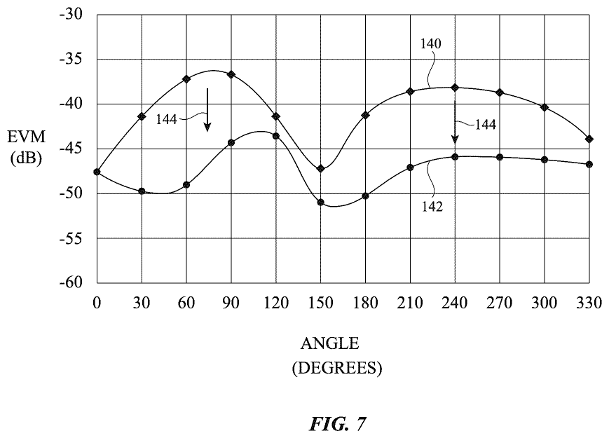

This may serve to optimize or improve the radio-frequency performance of phased antenna array 60. For example, dynamically adjusting bias voltages VB based on measured final-stage voltage gains GV across phased antenna array 60 may serve to minimize the error vector magnitude (EVM) of phased antenna array 60. Curve 140 of FIG. 7 plots EVM as a function of antenna angle θ in the absence of dynamic bias voltage adjustment based on final-stage voltage gains GV (e.g., in implementations where operation 106 of FIG. 5 is omitted). Curve 142 plots EVM with dynamic bias voltage adjustment based on final-stage voltage gains GV (e.g. in implementations where wireless circuitry 24 performs operation 106 of FIG. 5). As shown by arrows 144, dynamically adjusting bias final-stage bias voltages based on measured final-stage voltage gains GV may serve to minimize EVM of the array even as antenna impedance varies across the array. Curves 120-142 of FIGS. 6 and 7 may have other shapes in practice.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

The methods and operations described above in connection with FIGS. 1-7 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 and/or wireless communications circuitry 24 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry in wireless circuitry 24, processing circuitry 18 of FIG. 1, etc.). The processing circuitry may include microprocessors, application processors, digital signal processors, central processing units (CPUs), application-specific integrated circuits with processing circuitry, or other processing circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is illustrative and various modifications can be made to the described embodiments. The foregoing embodiments may be implemented individually or in any combination.

What is claimed is:

1. Wireless circuitry comprising:
a first antenna fed by a first radio-frequency transmission line path;
a first power amplifier on the first radio-frequency transmission line path and including a first series of amplifier stages;
a first voltage gain detector coupled around a final amplifier stage in the first series of amplifier stages and configured to detect a first voltage gain of the final amplifier stage in the first series of amplifier stages; and
biasing circuitry configured to adjust a first bias voltage of the final amplifier stage in the first series of amplifier stages based on the first voltage gain detected by the first voltage gain detector.

2. The wireless circuitry of claim 1, further comprising:
a second antenna fed by a second radio-frequency transmission line path;
a second power amplifier on the second radio-frequency transmission line path and including a second series of amplifier stages; and
a second voltage gain detector coupled around a final amplifier stage in the second series of amplifier stages and configured to detect a second voltage gain of the final amplifier stage in the second series of amplifier stages, wherein the biasing circuitry is configured to adjust a second bias voltage of the final amplifier stage in the second series of amplifier stages based on the second voltage gain detected by the second voltage gain detector.

3. The wireless circuitry of claim 2, wherein the first antenna and the second antenna form part of a phased antenna array configured to form a signal beam in a beam pointing direction and wherein the first and second power amplifiers are configured to adjust the beam pointing direction over time.

4. The wireless circuitry of claim 2, wherein the biasing circuitry is configured to increase the first bias voltage responsive to the first voltage gain being below a first threshold and is configured to decrease the second bias voltage responsive to the second bias voltage gain exceeding a second threshold.

5. The wireless circuitry of claim 1, wherein the biasing circuitry is configured to decrease the first bias voltage when the first voltage gain voltage exceeds a first threshold and is configured to increase the first bias voltage when the first voltage gain is less than the first threshold.

6. The wireless circuitry of claim 1, wherein the biasing circuitry stores a lookup table (LUT) mapping bias voltages to voltage gains and wherein the biasing circuitry is configured to adjust the first bias voltage of the final amplifier stage in the first series of amplifier stages based on values stored in the LUT.

7. The wireless circuitry of claim 1, wherein the first voltage gain detector is coupled to a first node on the radio-frequency transmission line path over a first signal line and is coupled to a second node on the radio-frequency transmission line path over a second signal line, the final stage in the first series of amplifier stages being interposed on the radio-frequency transmission line path between the first node and the second node.

8. The wireless circuitry of claim 7, wherein the first voltage gain detector is configured to measure an input voltage of the final stage in the first series of amplifier stages over the first signal line, is configured to measure an output voltage of the final stage in the first series of amplifier stages over the second signal line, and is configured to generate the first voltage gain based on the input voltage and the output voltage.

9. The wireless circuitry of claim 8, wherein the first voltage gain detector is configured to transmit a signal that identifies the first voltage gain to the biasing circuitry, the biasing circuitry is configured to identify a magnitude for the first bias voltage based on the signal, and the biasing circuitry is configured to supply the first bias voltage to the final amplifier stage in the first series of amplifier stages at the identified magnitude.

10. Wireless circuitry comprising:
a set of antennas configured to transmit radio-frequency signals;
a set of power amplifiers communicatively coupled to the set of antennas;
a set of phase shifters communicatively coupled to the set of antennas, wherein the set of power amplifiers and the set of phase shifters are configured to control the set of antennas to transmit the radio-frequency signals within a signal beam at a beam pointing angle;
a set of voltage gain detectors coupled around final stages in the set of power amplifiers and configured to measure voltage gains of the final stages in the set of power amplifiers while the set of antennas transmits the radio-frequency signals within the signal beam at the beam pointing angle; and
biasing circuitry configured to adjust, based on the measured voltage gains, bias voltages supplied to the final stages in the set of power amplifiers while the set of antennas transmits the radio-frequency signals within the signal beam at the beam pointing angle.

11. The wireless circuitry of claim 10, wherein the biasing circuitry is configured to adjust, while the set of antennas transmits the radio-frequency signals within the signal beam at the beam pointing angle, the bias voltages supplied to the final stages in the set of power amplifiers by different amounts across the set of power amplifiers.

12. The wireless circuitry of claim 11, wherein the biasing circuitry is configured to adjust the bias voltages supplied to the final stages in the set of power amplifiers in a manner that reduces a variation in the voltage gains across the set of voltage detectors.

13. The wireless circuitry of claim 12, wherein the biasing circuitry is configured to supply the bias voltages to the final stages in the set of power amplifiers at a first set of magnitudes at a first time while the set of antennas transmits the radio-frequency signals in the signal beam at the beam pointing angle and is configured to supply the bias voltages to the final stages in the set of power amplifiers at a second set of magnitudes at a second time while the set of antennas transmits the radio-frequency signals in the signal beam at the beam pointing angle, wherein the second set of magnitudes is different than the first set of magnitudes.

14. A method of transmitting a radio-frequency signal comprising:
transmitting, using a phased antenna array that includes at least a first antenna and a second antenna, the radio-frequency signal within a signal beam;
amplifying, using a first power amplifier biased by a first bias voltage, the radio-frequency signal transmitted by the first antenna;
measuring, using a first voltage gain detector, a first voltage gain of a final amplifier stage in the first power amplifier while the first antenna transmits the radio-frequency signal within the signal beam; and
adjusting, using biasing circuitry while the first antenna transmits the radio-frequency signal within the signal beam, the first bias voltage based on the first voltage gain measured by the first voltage gain detector.

15. The method of claim 14, further comprising:
amplifying, using a second power amplifier biased by a second bias voltage, the radio-frequency signal transmitted by the second antenna;
measuring, using a second voltage detector, a second voltage gain of a final amplifier stage in the second power amplifier while the second antenna transmits the radio-frequency signal within the signal beam; and
adjusting, using the biasing circuitry while the second antenna transmits the radio-frequency signal within the signal beam, the second bias voltage based on the second voltage gain measured by the second voltage gain detector.

16. The method of claim 15, wherein adjusting the first and second bias voltages comprises adjusting the first and second bias voltages in a manner that reduces a variation between the first voltage gain and the second voltage gain.

17. The method of claim 14, wherein adjusting the first bias voltage comprises:
reducing the first bias voltage when the first voltage gain measured by the first voltage gain detector exceeds a first threshold; and
increasing the first bias voltage when the first voltage gain measured by the first voltage gain detector is less than a second threshold.

18. The method of claim 14, further comprising:
transmitting, using the phased antenna array, the radio-frequency signal within an additional signal beam at a different beam pointing angle than the signal beam;
measuring, using the first voltage gain detector, a third voltage gain of the final amplifier stage in the first power amplifier while the first antenna transmits the radio-frequency signal within the additional signal beam; and
adjusting, using biasing circuitry, the first bias voltage based on the third voltage gain measured by the first voltage gain detector while the first antenna transmits the radio-frequency signal within the additional signal beam.

19. The method of claim 14, wherein adjusting the first bias voltage comprises adjusting the first bias voltage in a manner that mitigates an effect of an external object loading the phased antenna array by different amounts across the phased antenna array.

20. The method of claim 14, wherein measuring the first voltage gain comprises:
measuring an input voltage of the final amplifier stage in the first power amplifier;
measuring an output voltage of the final amplifier stage in the first power amplifier; and
dividing the output voltage by the input voltage.
